(19) United States
(12) Patent Application Publication
(10) Pub. No.: US 2026/0279219 A1
(43) Pub. Date: Sep. 17, 2026

(54) COMPUTER-IMPLEMENTED SYSTEM AND METHOD FOR TRAINING FOOD SERVICE INDUSTRY EMPLOYEES

(71) Applicant: Beth Anne Hussey, Bloomfield Hills, MI (US)

(72) Inventor: Beth Anne Hussey, Bloomfield Hills, MI (US)

(21) Appl. No.: 19/672,642

(22) Filed: May 9, 2026

Related U.S. Application Data
(63) Continuation-in-part of application No. 17/877,898, filed on Jul. 30, 2022.

(51) Int. Cl. G09B 7/04

(52) U.S. Cl. CPC G09B 7/04

(57) ABSTRACT

A computer-implemented system for dynamically synchronization of point-of-sale establishment-specific data and adaptive training content within a networked food service environment. The system comprising at least one central server configured to store one or more databases and execute instructions and a plurality of computing distributed nodes to automatically intercept establishment-specific data directly from the point-of-sale interface systems. Through automated transformation, the system converts point-of-sale data into flashcard learning content, ensuring training modules remain in parity with live operational data without manual intervention. The platform evaluates employee performance via randomized testing modules and generates asynchronous auditable training records that track progress across multiple shifts. By cross-referencing real-time performance metrics with training shift data, the system dynamically modifies subsequent instructional sequences. Employee trainees interact with a graphical user interface that provides a real-time dashboard of synchronized assignments, progress, and test scores, ensuring a seamless alignment between current menu requirements and staff competency.

### CROSS REFERENCE TO RELATED APPLICATIONS

This Continuation-In-Part Patent Application claims the benefit of priority based on U.S. patent application Ser. No. 17/877,898 filed on Jul. 30, 2022, which is hereby incorporated in its entirety by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON COMPACT DISC

Not Applicable

### BACKGROUND OF THE INVENTION

### 1. Field of the Invention

The present invention relates generally to the training of employees in the food service industry and, more particularly, to a computer-implemented system and method for training food service industry employees who serve customers at various eating and drinking establishments.

### 2. Background Art

The food service industry is one of largest industries by employment in the United States. The operation of restaurants, bars, pubs, diners, catering venues and the other various other eating and drinking establishments rely heavily on servers and bartenders to interface with customers. These servers and bartenders are often the “face” of the establishment and provide customers with a number of services to ensure the customers have an enjoyable and even an exceptional dining and/or drinking experience. This server/bartender and customer interface helps to generate a reputation for a particular establishment that often may lead to the success or demise of the business. To ensure the customer has that exceptional experience at a dining establishment and, in turn, to ensure the success of the business, owners and operators spend both time and money to train servers and bartenders to deliver just such an experience to each and every customer.

Most server or bartender training programs in these establishments consist of the manager simply pairing a new server or bartender, the trainee, with the most experienced server or bartender, the trainer, at the place of business. Typically, the trainer reluctantly agrees to do so because the trainer usually does not have a choice and the trainer is expected to train the new server or bartender. Training is mainly “on the job” with the trainee simply following the actions of the trainer throughout the training period. In many cases, there are no training materials for the trainee to learn from when outside of work. Even if there are training materials, they are often outdated and do not include the present menu items, product offerings or company policies that have been implemented and/or updated.

Further, many servers and bartenders often work for tips to enhance their wages. These experienced workers not only know they have to provide the exceptional service to generate more wages through tips, they must also work to manage a number of tables and do so quickly to maximize their potential tip amount. Having to train a new server or bartender slows the work of the experienced server or bartender and may lead to lost tip wages for the training period leading to even further reluctance to work with the trainee. This leads to a new employee that does not learn to be a proper server or bartender, a potential for lower tips for the new employee, dissatisfaction with the position, loss of employees and ultimately damage to the reputation and lost profits for the business.

Establishments known to have reputable training programs for new servers and bartenders typically offer no more than a book or three ring binder of tens or even hundreds of pages of antiquated, dry and technical information the new employee is expected to read and retain during their training period. After completion of the training period, the new server or bartender is presented with an exam to test their knowledge of the establishment's menu offerings, how best to welcome and treat customers, how to handle customer disputes and the like. The exams may create stress and anxiety in the new employee and often they cram to take the exams to ensure they earn the position, but often forget what they have studied and take the next several months actually and slowly learning to be an actual server or bartender once again leading to frustration for the new employee.

Employee retention is another issue these establishments face on an almost daily basis. The average tenue for a restaurant employee in the United States is about one month. This extremely short period is directly related to the frustration new employees feel because they have not been trained properly and are overwhelmed by the number of tasks and working with numerous customers on a daily basis and often for the first time.

Employees are the most important asset for a restaurant or other type of eating and drinking establishment. Yet, owners of these service industry businesses invest little time, money and other resources into the training of new employees and creating a culture and environment that will enable the new employee to flourish and enhance the business. Owners invest in Restaurant Management Software (RMS) Systems to enhance point-of-sale transactions, reservations, table management, food costing, inventory management, waitlist, accounting, cash flow and online ordering. However, these RMS Systems do not address the restaurants most important asset, employees, and how to effectively train those employees.

Therefore, a need exists for a computer-implemented system and a method, a fun and engaging training program for servers and bartenders, that will enable both the trainee and trainer to follow a step-by-step process that maintains an active human-to-human interface and a hands-on training approach to train food service industry employees. The computer-implemented system and method for training will help to ease the anxiety and frustration of the new employee while removing the reluctance of the trainer to train and ensure a properly trained new employee can flourish and enhance the business even further.

### BRIEF SUMMARY OF THE INVENTION

A computer-implemented system for dynamically synchronizing point-of-sale data and adaptive training content within a networked food service environment, comprising: at least one central server comprising a data-transformation engine and one or more relational databases specific to a food service establishment and employees, the one or more relational databases of establishment-specific data including: menu data comprising a plurality of menu items, menu sub-items, and core products; training shift data comprising shift set-up, pre-shift information, training shift data, and training module content; a flash card module comprising a plurality of flash card learning content; and a flash card test module comprising a plurality of flash card testing content presented randomly to an employee trainee as determined by the at least one central server; a plurality of distributed computing nodes configured as point-of-sale interface systems, including at least one first computer and at least one second computer communicatively coupled to the at least one central server via the computer network; wherein the at least one central server executes the computer-implemented system comprising executable instructions that: automatically intercepts the establishment-specific data from the point-of-sale interface systems to capture real-time modifications to the establishment-specific data; execute a dynamic mapping algorithm that transforms the establishment-specific data from the point-of-sale interface systems into the flash card learning content, aligns the flash card learning content with respective the training module content, and ensures the flash card learning content automatically updates and maintains parity with the establishment-specific data through the point-of-sale interface systems all without manual intervention; automatically assigns a designated flash card module based on the identified employee trainee record in response to completion data from corresponding training shift data received from the at least one second computer; executes a sequence of sad flash card testing content within the flash card test module for delivery to the employee trainee via the at least first computer or the at least one second computer; evaluate and score responses to the flash card testing content from the employee trainee and store performance metrics within an employee trainee profile database; generate an asynchronous auditable training record by synchronizing the employee trainee profile database and the training shift data between the at least one first computer and the at least one second computer across a plurality of training shifts; monitor for changes to the training shift data and, upon detecting a modification, automatically synchronize and maintain updated training content across the at least one central server, the at least one first computer, and the at least one second computer without manual intervention; dynamically modify a subsequent training sequence for the trainee by cross-referencing real-time performance metrics retrieved from the auditable training record with results from the flashcard test module; and update the employee trainee interface in real time to reflect the synchronized training assignments and performance data retrieved from the at least one central server; wherein the at least one first computer presents to the employee trainee a graphical user interface comprising a training dashboard displaying the training progress, training assignments, and flash card test scores of the employee trainee retrieved in real time from the at least one central server.

### BRIEF DESCRIPTION OF THE SEVERAL VIEWS OF THE DRAWINGS

The features and inventive aspects of the present invention will become more apparent from the following detailed description, claims, and drawings, of which the following is a brief description:

FIG. 1A is a diagram illustrating a computer-implemented system for training food service industry employees according to an embodiment of the present invention;

FIG. 1B-1E are exemplary screens than may be accessed on a computer monitor of a computer-implemented system for training food service industry employees according to an embodiment of the present invention;

FIG. 2 is a first flow chart of the initial set up process using a general information module for a business or employer to begin to establish the computer-implemented system for training food service industry employees according to an embodiment of the present invention;

FIG. 3 is a second flow chart for searching and reviewing polices of an eating and drinking establishment using a policy module according to an embodiment of the present invention;

FIG. 4A is a third flow chart for inputting a variety of menu items by the employer of the establishment into the computer-implemented system using a menu module according to an embodiment of the present invention;

FIG. 4B is a fourth flow chart for inputting a variety of menu sub items by the employer of the establishment into the computer-implemented using a sub-menu module system according to an embodiment of the present invention;

FIG. 4C are screen shots depicting how the menu items and menu sub items of the establishment may be accessed by the employees through a computer interface such as a smartphone according to an embodiment of the present invention;

FIG. 5A is a fifth flow chart for inputting a variety of core products by the employer of the establishment into the computer-implemented system using a core products module according to an embodiment of the present invention;

FIG. 5B are screen shots depicting how the core products of the establishment may be accessed by the employees through a computer interface such as a smartphone according to an embodiment of the present invention;

FIG. 6A is a sixth flow chart for inputting information by the employer to establish a training shift for the new employee in the computer-implemented system using a shift set-up module according to an embodiment of the present invention;

FIG. 6B are screen shots depicting how the training shift of the automated training system may be accessed by the new employee through a computer interface such as a smartphone according to an embodiment of the present invention;

FIG. 6C-6G are seventh, eighth, ninth, tenth and eleventh flow charts for accessing flash card modules of the computer-implemented system for training food service industry employees using a flash card module according to an embodiment of the present invention;

FIG. 6H is a twelfth flow chart for accessing a flash card review module of the computer-implemented system for training food service industry employees according to an embodiment of the present invention;

FIG. 6I is a thirteenth flow chart for accessing a flash card test module of the computer-implemented system for training food service industry employees according to an embodiment of the present invention;

FIG. 6J-6K are screen shots depicting how the flash card modules of the computer-implemented system for training food service employees may be accessed by the new employee through a computer interface such as a smartphone according to an embodiment of the present invention;

FIG. 7A is a thirteenth flow chart for inputting information of the new employee into the computer-implemented system using a new employee module according to an embodiment of the present invention;

FIG. 7B is a screen shot depicting the information of a new employee of an establishment accessed through a computer interface such as a smartphone according to an embodiment of the present invention; and

FIG. 8 is a fourteenth flow chart for inputting and dispersing pre-shift information and announcements to employees through the computer-implemented training system using a pre-shift module according to an embodiment of the present invention.

### DETAILED DESCRIPTION OF THE INVENTION

Referring now to the drawings, preferred illustrative embodiments of the present invention are shown in detail. Although the drawings represent embodiments of the present invention, the drawings are not necessarily to scale and certain features may be exaggerated to better illustrate and explain the present invention. Further, the embodiments set forth herein are not intended to be exhaustive or otherwise to limit or restrict the invention to the precise forms and configurations shown in the drawings and disclosed in the following detailed description.

A computer-implemented system and method for training food service industry employees is provided. Employees of an eating and drinking establishment in the food service industry, such as restaurants, bars, pubs, diners, catering venues and the other various other eating and drinking establishments, are the most important asset to that establishment. Customer servers and bartenders are the face of the establishment and have a large impact on the success or failure of the business.

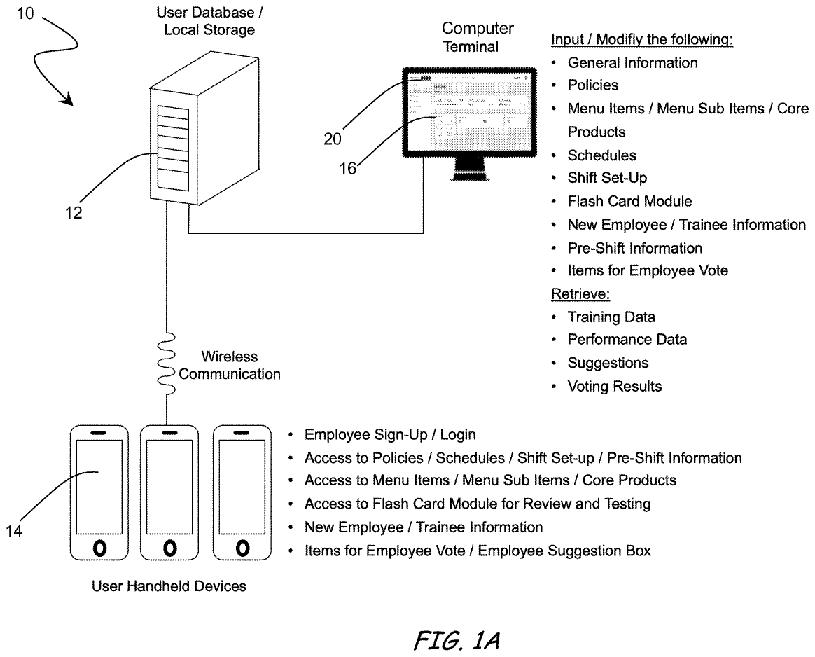

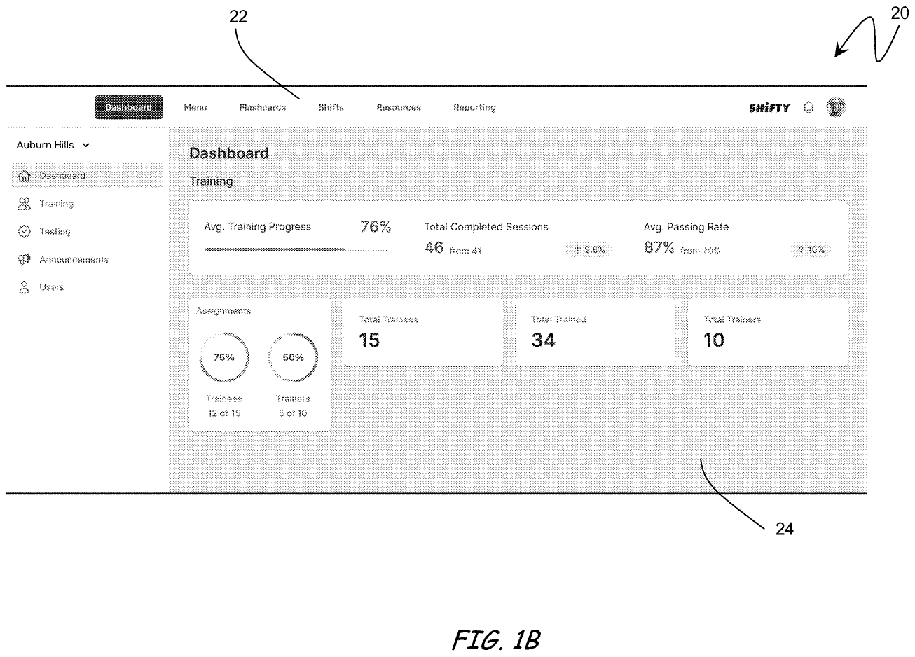

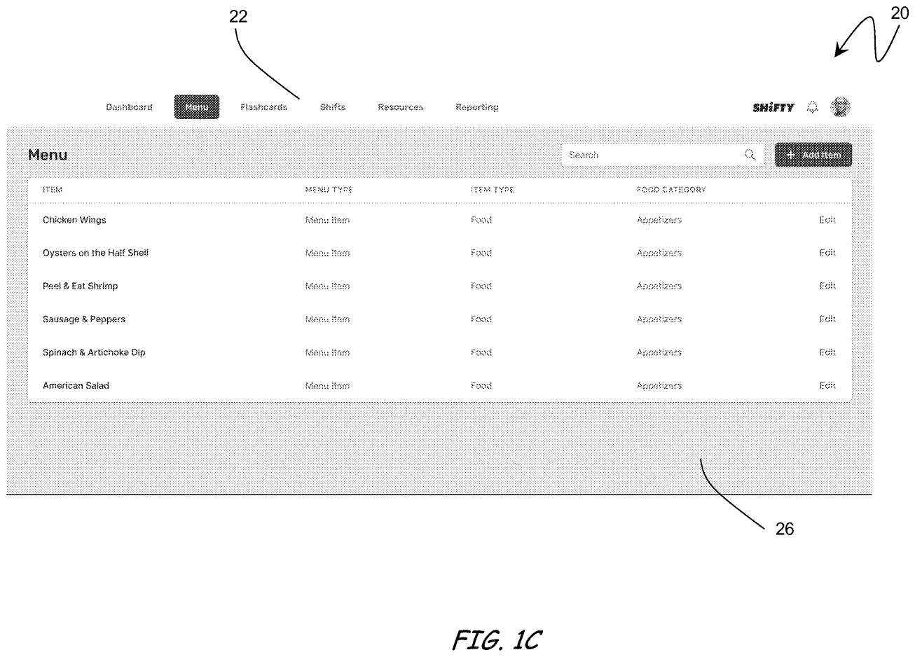

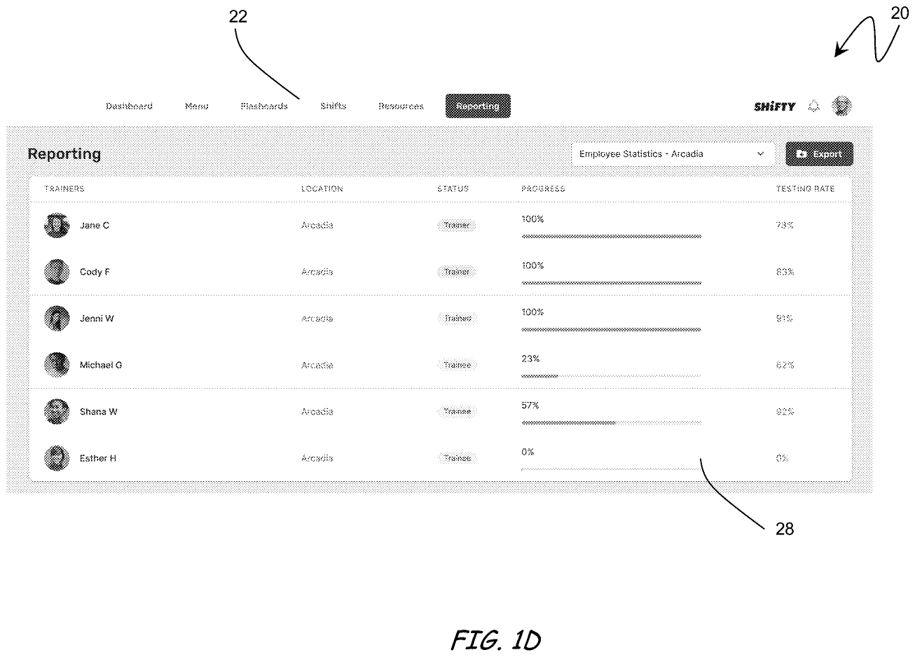

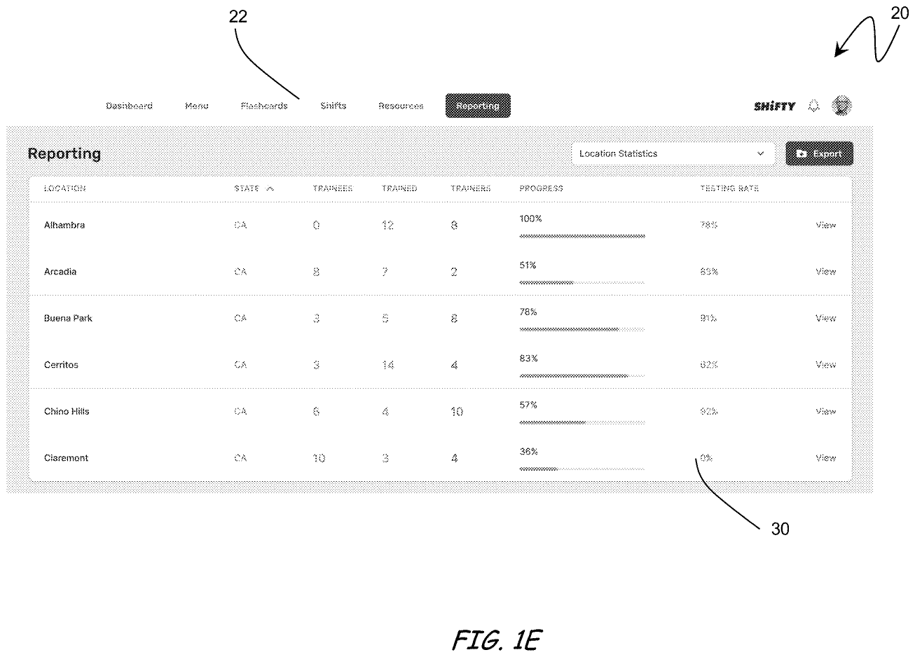

According to an embodiment of the present invention, a computer-implemented system for training food service industry employees 10 is illustrated in FIG. 1A. Training system 10 includes at least one central server 12 and at least one first computer node 14 capable of communicating and exchanging information with central server 12. System 10 also includes at least one second computer node 16 capable of communicating and exchanging information with server 12 and first computer 14.

Central Server 12 is a computer as well that stores a number of relational databases that are used in the operation of an establishment and may be used in training system 10. Server 12 may include databases that have been used to create and maintain an account by a user of system 10. Such relational databases may include general information about the eating and drinking establishment or restaurant, employee information, employer policies, menu items, menu sub items, core products, employee schedules, shift set-up and pre-shift information, employee training modules and the like required to operate the establishment efficiently and effectively. Central sever 12 may be one of many separate and distinct computers to interface with first computer 14 and second computer 16.

First computer 14 may be a hand-held device such as a smartphone or tablet or a computer terminal such as a desktop style computer and monitor that communicates with server 12. An employee of the restaurant or establishment may use first computer 14 to access the above-described information stored on server 12 when the employee is a trainee or a trainer and uses training system 10 to train to be a server or bartender at the restaurant. First computer 14 may also be used as a point-of-sale interface system to enter and retrieve any data stored in the relational databased on server 12 and related to the food service establishment such as tracking and managing employee training, tracking inventory, managing customer data, generating sales reports and the like. First computer 14 may be one of many separate and distinct computers to interface with server 12 and second computer 16.

Second computer 16 may be a hand-held device such as a smart phone or tablet or a computer terminal such as a desktop style computer and monitor. Second computer 16 also communicates with server 12. Second computer 16 may also be used as a point-of-sale interface system to enter and retrieve any data stored in the relational databased on server 12 and related to the food service establishment such as tracking and managing employee training, tracking inventory, managing customer data, generating sales reports and the like. Further, second computer 16 may be used to input and modify any of the general information about the eating and drinking establishment or restaurant, employee information, employer policies, menu items, menu sub items, core products, employee schedules, shift set-up and pre-shift information, employee training modules and the like. Second computer 16 may also be used to retrieve data provided by employees at first computer 14 through server 12. Such data may include employee suggestions, voting results and the like. Second computer 16 may be one of many separate and distinct computers to interface with server 12 and first computer 14.

FIG. 1B-1E illustrate typical screens of training system 10 that may be displayed on computer monitor 20 and accessed by first computer 14, second computer 16 and central server 12 according to an embodiment of the present invention. Owners, managers, employees and others accessing the screens may navigate to any of the screens by selecting a particular screen from a navigation strip 22 at the top of each screen. A training dashboard 24 may be included and used to indicate average training progress, total completed training sessions and an average passing rate for any training tests completed. Other information may be provided such as training assignments, the number of trainees, the number of trained employees and the number of trainers. A menu 26 may also be included to display all the different menu items, sub menu items and core products offered to customers by the eating and drinking establishment. A store specific reporting screen 28 and regional or national reporting screen 30 may also be included to reflect the status of a particular employee relative to training progress on reporting screen 28 and the status of a particular store and its employees relative to training progress on screen 30. It is important to note that FIG. 1B-1E are merely illustrative of the types of information that employees, managers, owners and others of drinking and eating establishments may access through screens on computer monitor 20 and by first computer 14, second computer 16 and central server 12. Many other screens may be added for access through computer monitor 20 and by first computer 14, second computer 16 and central server 12 to enhance training system 10 to further be used in training new employees of drinking and eating establishments.

Connectivity of servers 12, first computers 14 and second computers 16 may be accomplished with networks such as an internet and/or wireless network such as a cellular telephone network, a wired or wireless local area network (LAN) or wide area network (WAN), the cloud and the like. Training system 10 may be implemented on applications that run on a single or a variety of operating system platforms including, but not limited to Apple OS, WINDOWS, UNIX, IOS, ANDROID, SYMBIAN, LINUX or embedded operating systems such as VsWorks. Training system 10 may operate with various web browsers, including but not limited to Internet Explorer, Safari, Mozilla Firefox and others that access and communicate with various types of web pages constructed with various mark-up languages such as HTML and the like.

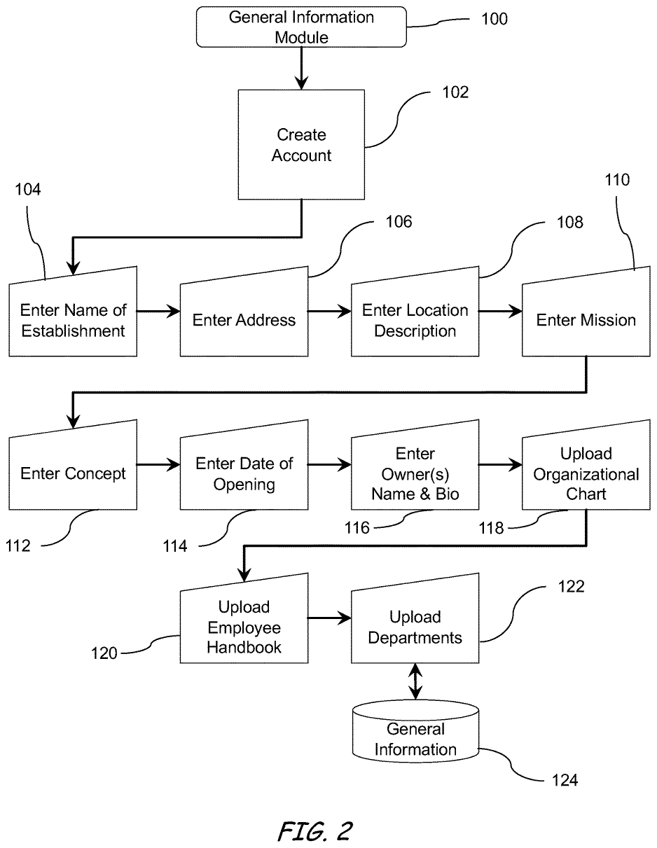

Referring now to FIG. 2-7B, the elements and operation of training system 10 will now be described in greater detail according to an embodiment of the present invention. An owner, operator or manager of a food industry establishment or restaurant desiring to use the services provided by training system 10 will first enable system 10 on second computer 16 by entering general information about the establishment or restaurant in the general information module 100 as illustrated in FIG. 2. The operator may create an account at step 102 and enter the name of the establishment at step 104 followed by the address of the establishment at step 106 as well as a location description at step 108. The operator may continue to enter the establishment's mission at step 110, concept at step 112, date of opening at step 114, if applicable, followed by biographies of the owners, operators and/or managers at step 116. The operator may also upload an organizational chart at step 118, upload the employee handbook, including any training materials, policies and the like, at step 120 and upload the different departments of the establishment at step 122. The above information may be stored and accessed on server 12 as a general information database at step 124. The general information database may be accessed by employees, including new employees during the hiring phase through first computer 14 or second computer 16 to begin to build the trust between the operator and new employee to transition into a smooth training period. It is important to note that the above listed information is not all inclusive and other information that may be pertinent to operate an establishment may be added to the general information.

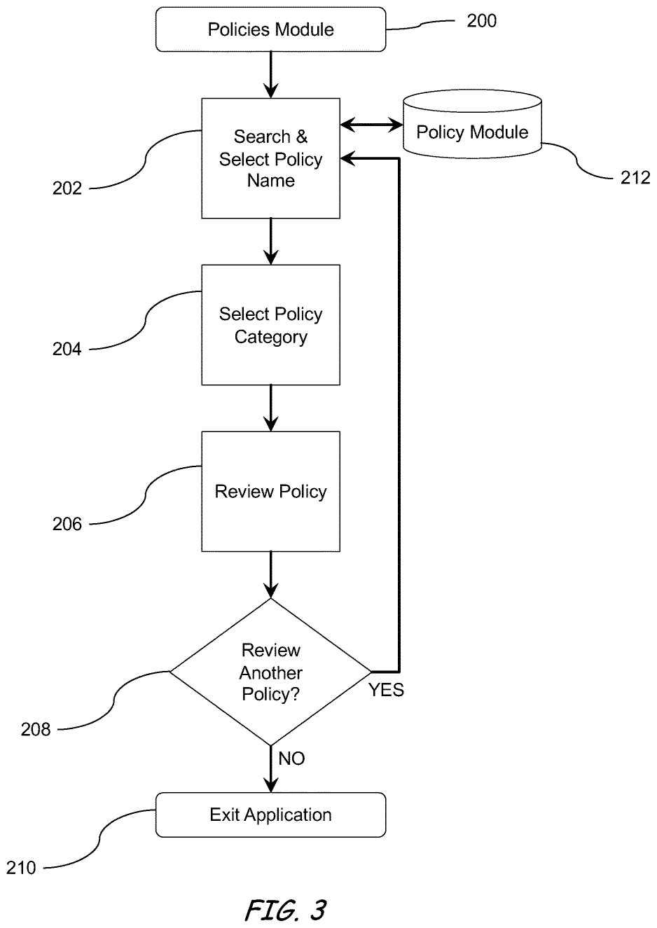

A policy module allows an operator to categorize and describe policies of the establishment in training system 10. Operators are able to add, modify or remove policies stored on server 12 in policy database 212 and operators may send notifications of policy changes to all employees and departments through training system 10. FIG. 3 illustrates how an employee may enter a policies module 200 and search for policies of the establishment stored on training system 10 at step 202 in policy database 212. New employees may find this search feature particularly useful while training and learning the polices for the first time. Seasoned employees will also find the policy search feature equally valuable to refresh themselves on the existing policies or to learn any new policies of the establishment. Employees may use first computer 14 or second computer 16 to access any of the policies stored on server 12 in policy database 212. Employees may also be required to acknowledge they have read and understand each of the policies of the establishment prior to beginning work.

An employee may search for a policy and select a specific policy name at step 202 and select a policy category at step 204. Employees may review that policy at step 206 and, upon completion of their review, may decide to review another policy at step 208. If the employee desires to review another policy, they will be returned to step 202 to begin a new search. Alternatively, the employee may exit the application step 210 if no further action on policies is to be taken. Having access to policies in this manner will enable new employees to have access to the establishment's policies for review at any time through first computer 14 or second computer 16 to further enhance the training of the new employee.

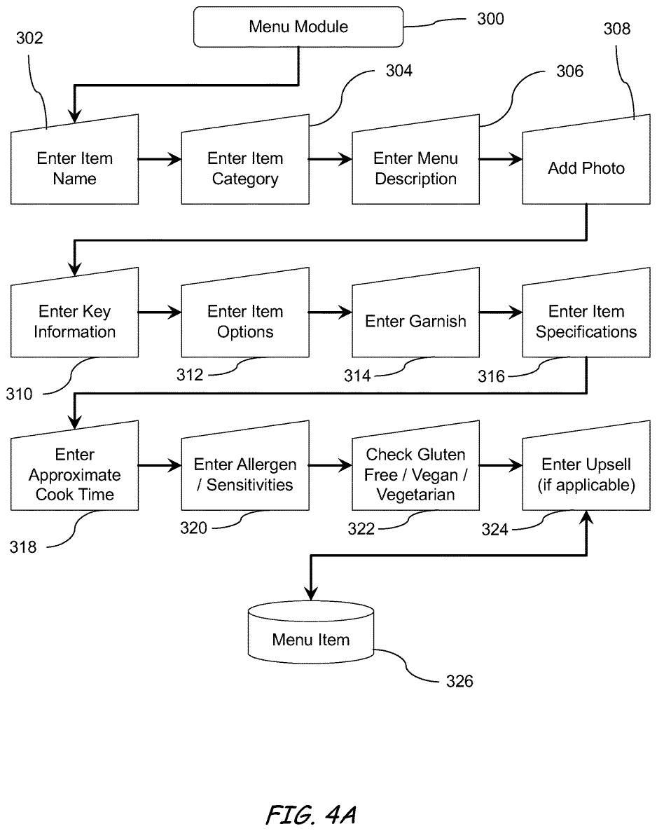

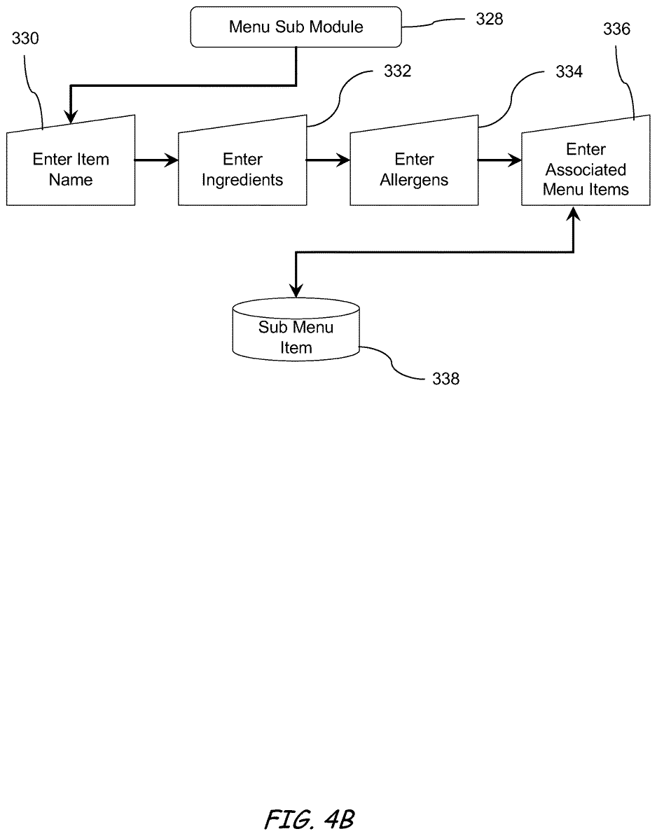

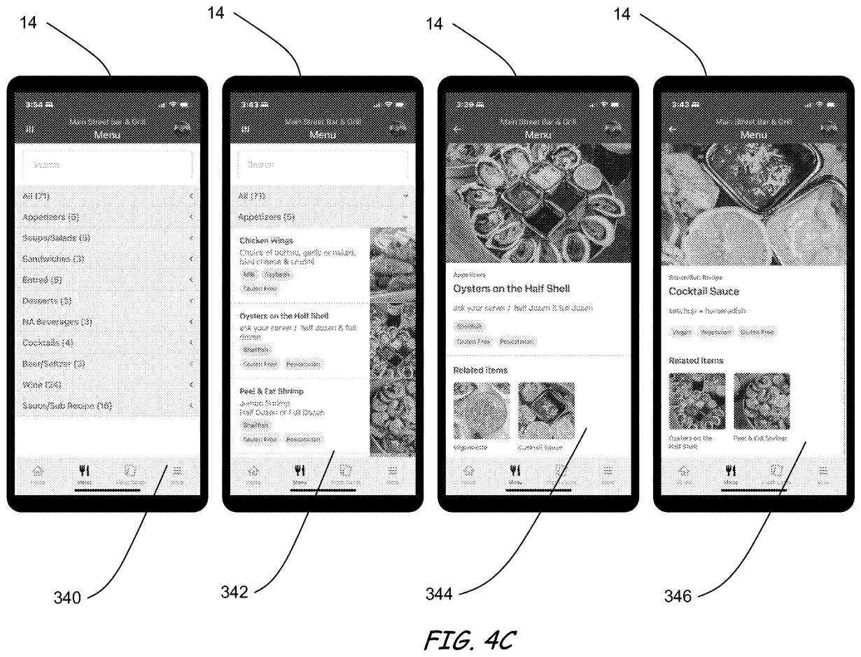

A menu module enables the operator to categorize all menu items, both food and beverage, in training system 10. The menu module is field based and data input is similar to the data input into a typical point-of-sale interface system. Operators are able to add, modify or remove menu items stored on server 12 in menu item database 326 with first computer 14 or second computer 16 and operators may send notifications of menu item changes to all employees and departments through training system 10. Menu items may also include menu sub items and core products, these menu sub items and core products being described below. FIG. 4A illustrates a menu module 300 and how an operator may enter menu items of the establishment to be stored in menu item database 326 on server 12 of training system 10.

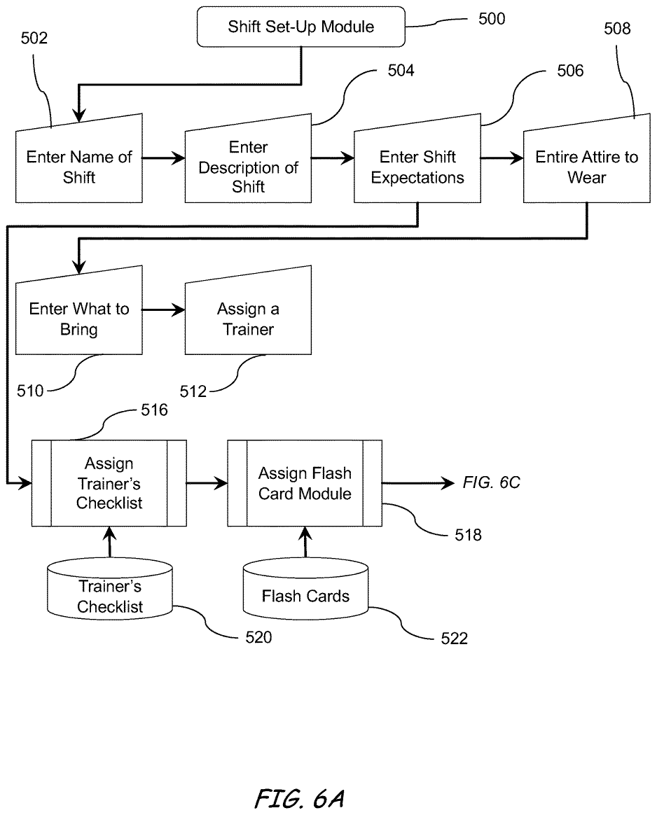

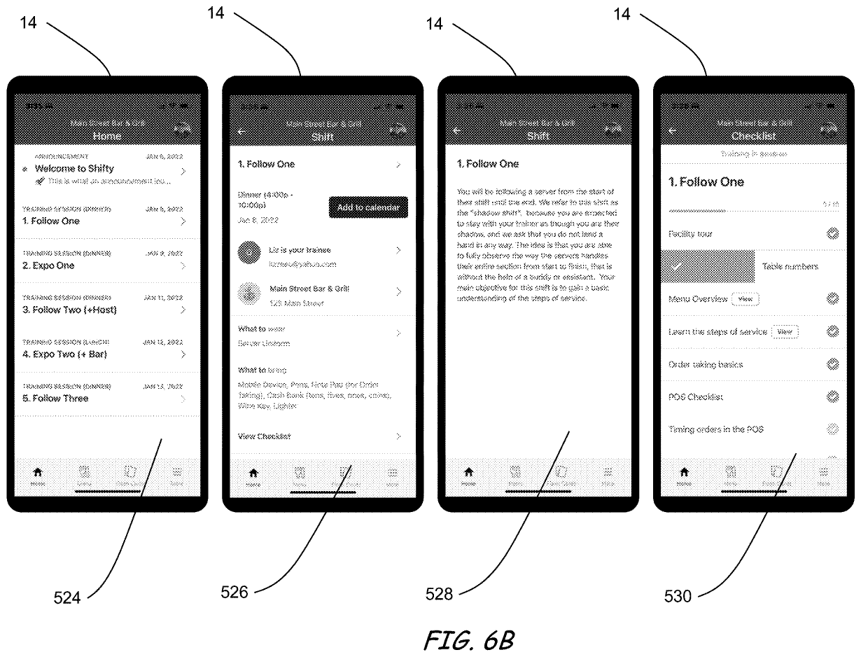

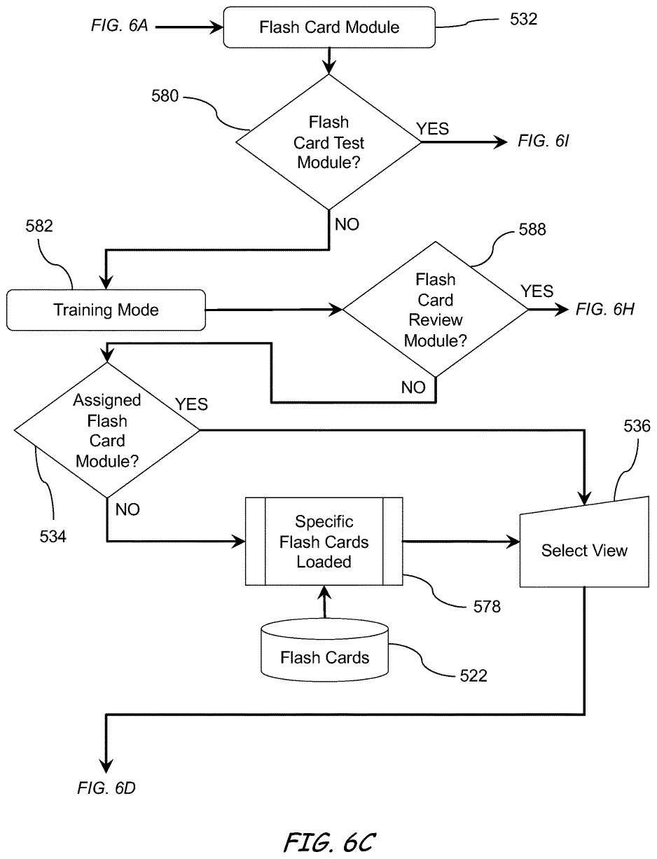

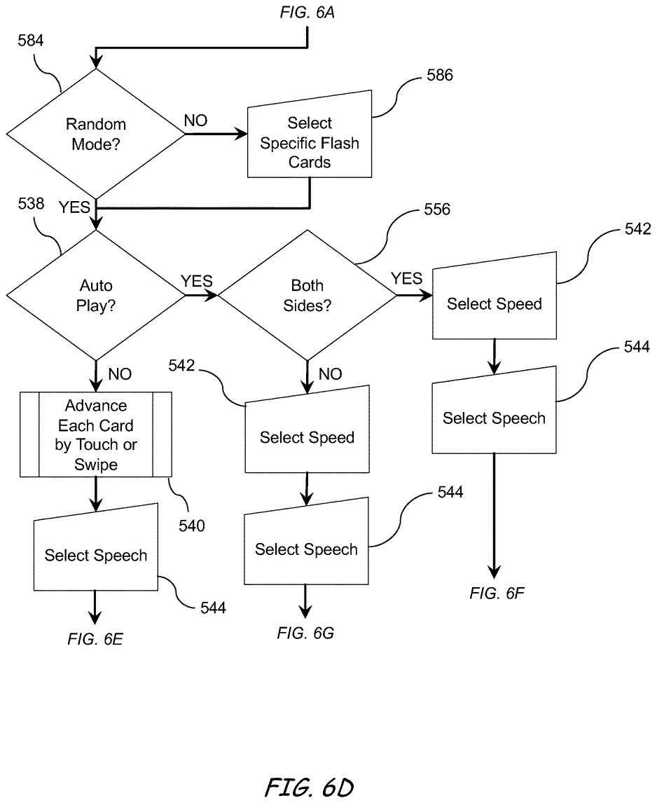

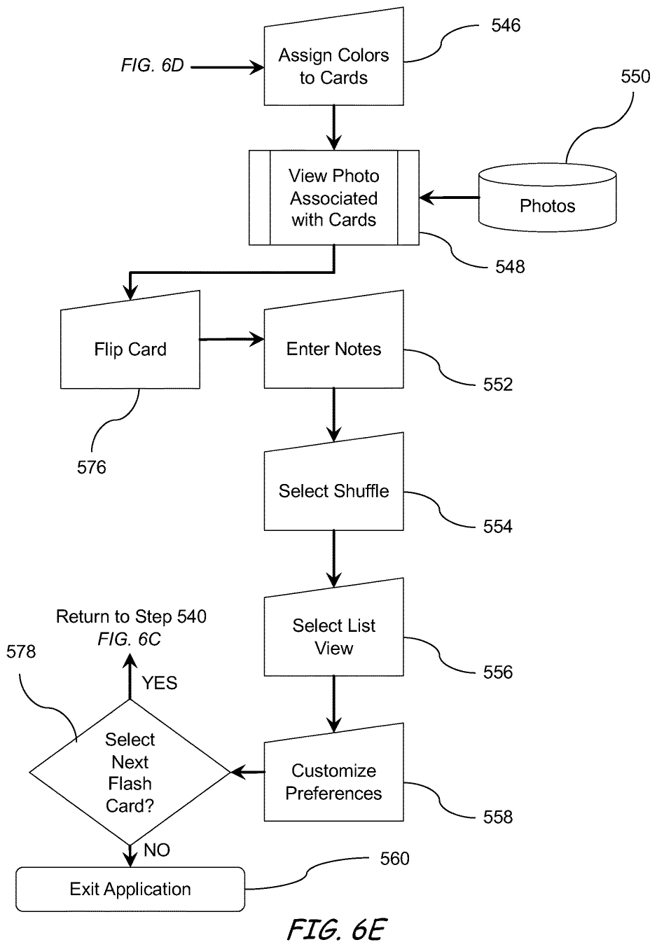

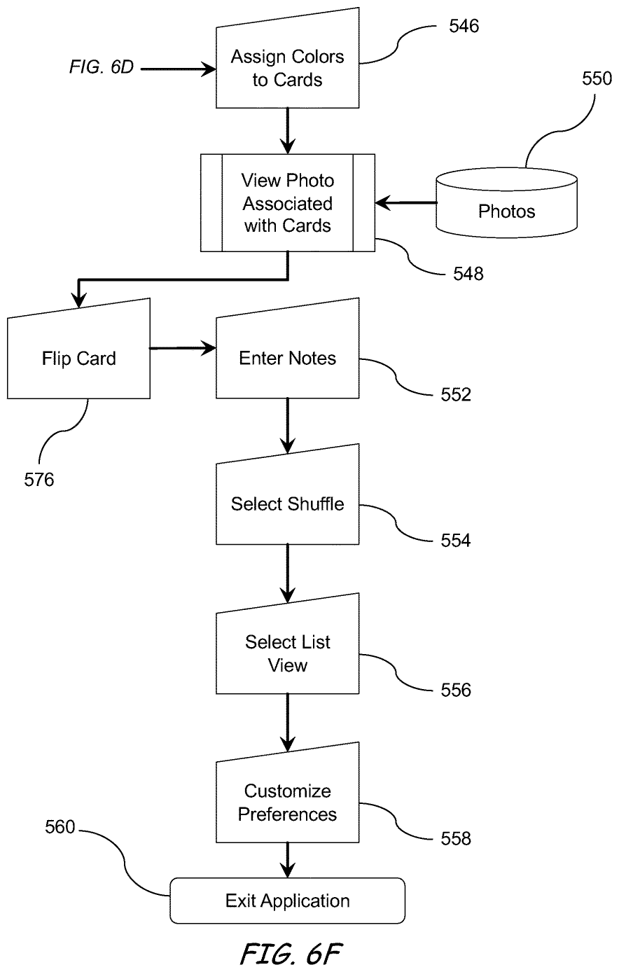

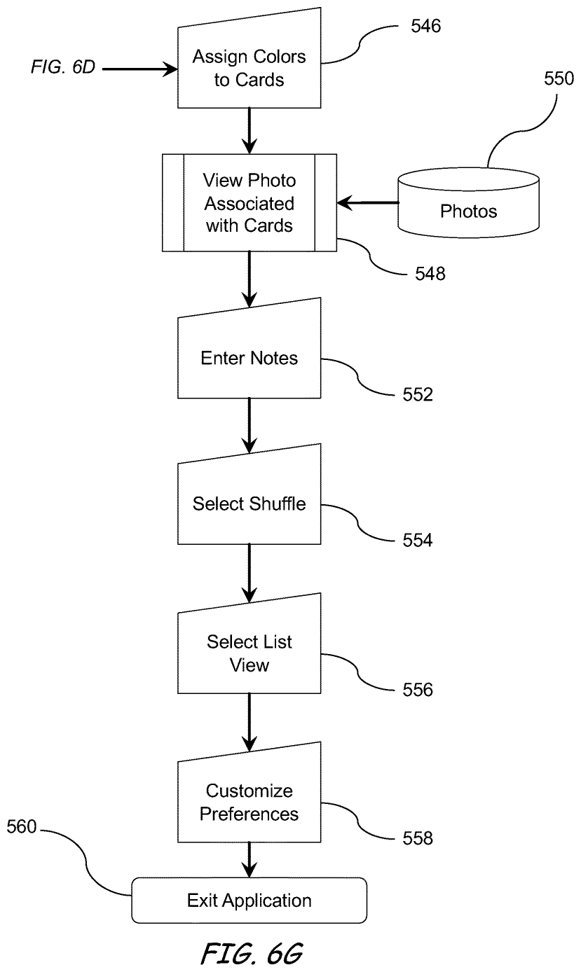

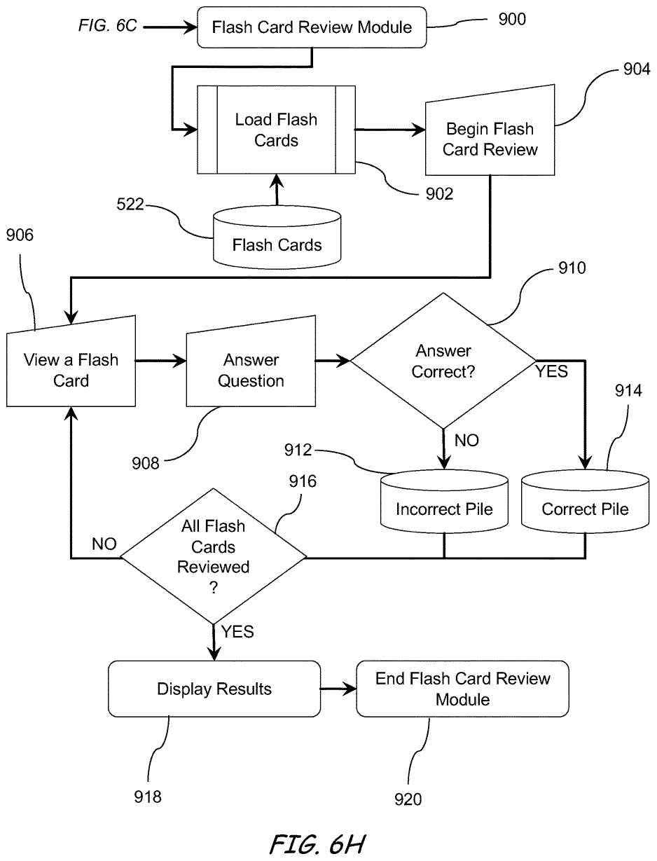

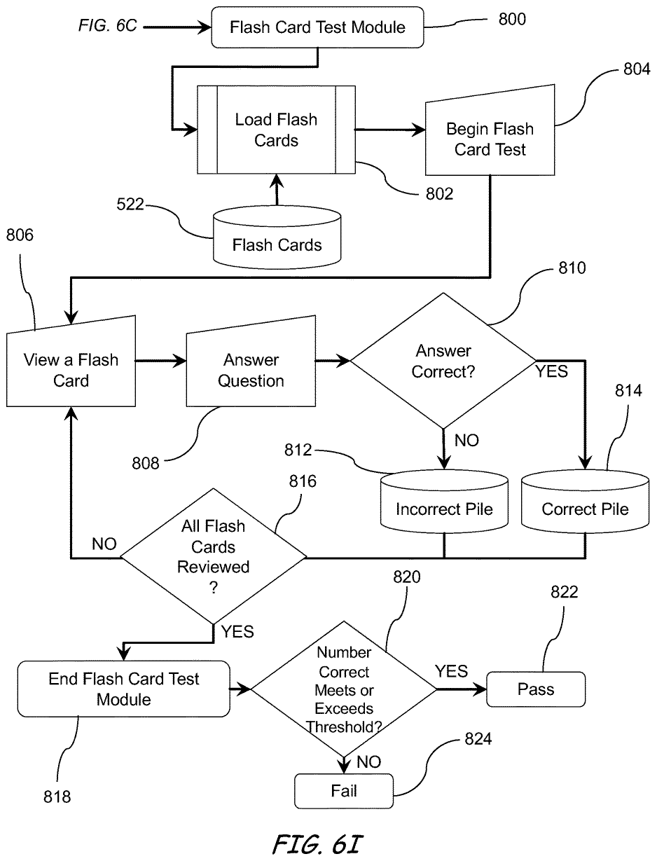

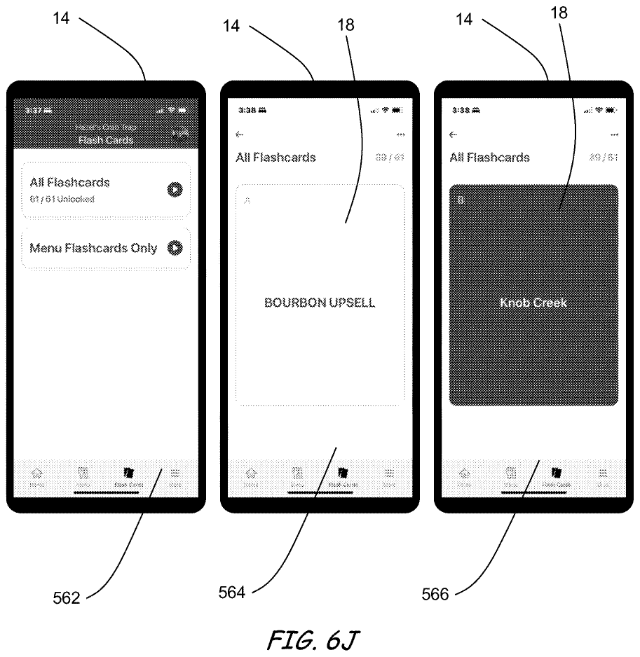

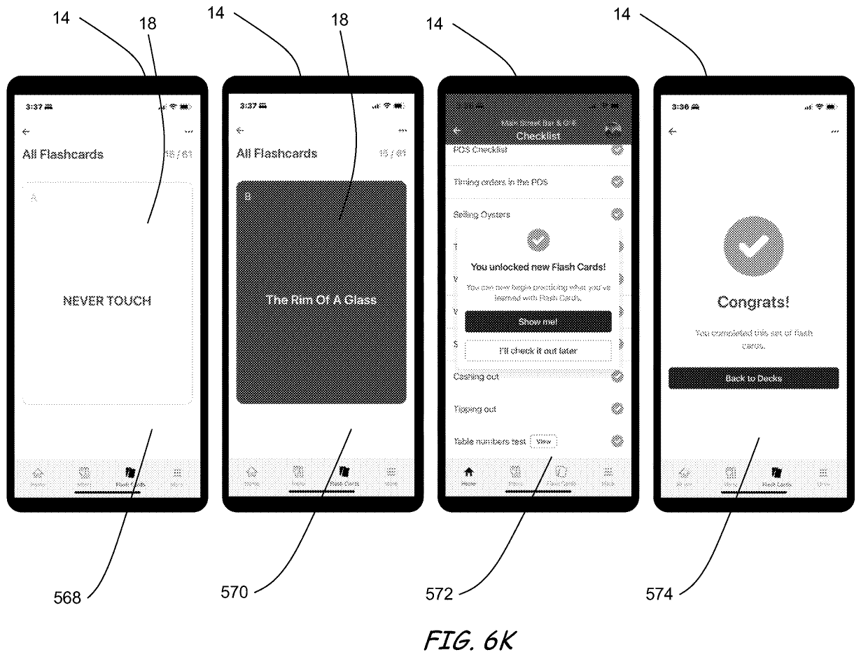

The operator may enter a particular menu item name (for example, oven fried chicken) at step 302 and assign the particular menu item to a category (for example entrée) at step 304. The operator may also add a description of the menu item at step 306 along with a photo at step 308. Key information such as, for example, four-piece meal, breast, thigh, wing, leg, mashed potato and green beans may be entered at step 310 and for use in a flash card module 532 (see FIG. 6C). Item options may be specified at step 312 and may also be included in flash card module 532. The operator may also enter a garnish at step 314 and item specifications such as plating, glassware, etc. at step 316. An approximate cook time may be entered by the operator at step 318 followed by any allergens/sensitivities at step 320. Whether a particular menu item is gluten free, vegan or vegetarian may be entered at step 322 and whether a particular menu item includes an opportunity to upsell (for example, add a second drumstick) may be entered at step 324. All the above menu item information may be stored and accessed through the menu item database 326 on central server 12.

Training system 10 will automatically generate a new menu item flash card 18 from the information entered by the operator into the point-of-sale interface system at first computer 14 or second computer 16 at steps 302 through 324 and stored on server 12 in flash cards database 522. The newly generated flash card 18 may be added to flash cards 18 used for training new employees in flash card module 532.

Further, a menu sub module 328 may be used to add the menu sub items to training system 10 as illustrated in FIG. 4B. The menu sub item name (for example, garlic-aoili) may be entered at step 330 along with the ingredients at step 332, any allergens at step 334 and which menu item the menu sub item is associated with at step 336. All the above sub menu item information may be stored and accessed through the sub menu item database 338 on central server 12.

Training system 10 will automatically generate a new sub menu item flash card 18 from the information entered by the operator into the point-of-sale interface system at first computer 14 or second computer 16 at steps 330 through 336 and stored on server 12 in flash cards database 522. The newly generated flash card 18 may be added to flash cards 18 used for training new employees in flash card module 532.

FIG. 4C depicts screen shots of all menu categories 340, a list of appetizers screen 342, a single appetizer screen 344 and a menu sub item screen 346 related to appetizer screen 342. All of the menu items and menu sub items entered by the operator and stored in server 12 may be viewed by an employee with first computer 14 as shown in FIG. 4C and second computer 16 as well.

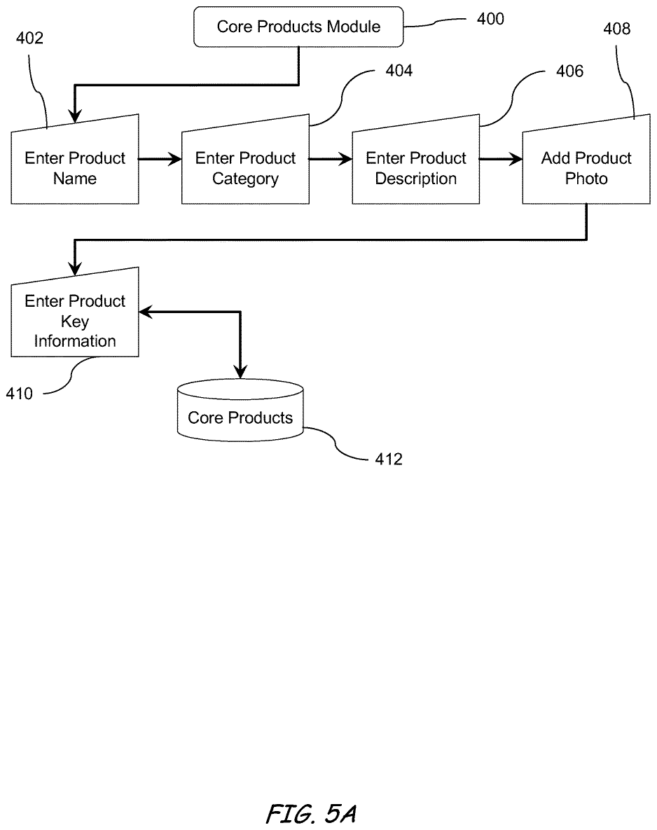

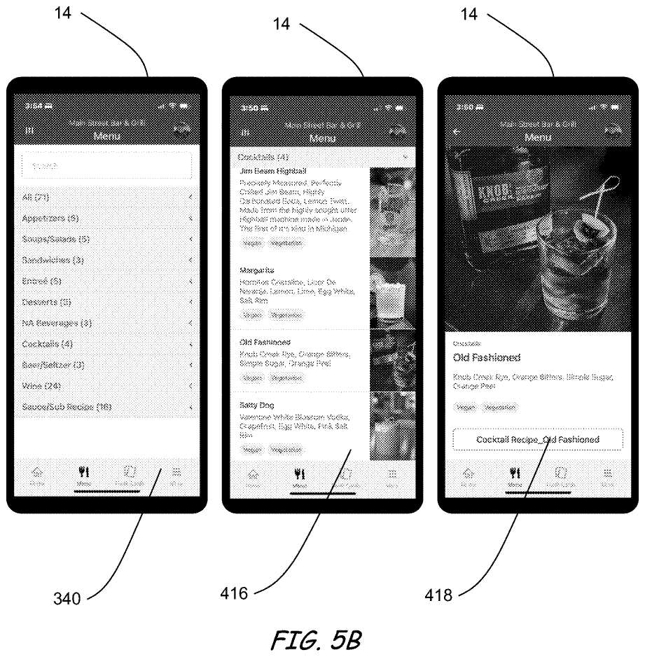

A core products module allows the operator to categorize all core products, typically bar items such as liquor, beer and wine products, in training system 10. The core products module is also field based and data input is similar to a typical point-of-sale interface system. Operators are able to add, modify or remove core products stored on server 12 with first computer 14 or second computer 16 and operators may send notifications of core product changes to all employees and departments through training system 10. FIG. 5A illustrates a core products menu 400 and how an operator may enter core products of the establishment into training system 10.

The operator may enter a particular core product name (for example, old fashioned) at step 402 and assign the particular core product to a category (for example cocktail) at step 404. The operator may also add a description of the core product at step 406 along with a photo at step 408. Key information such as, for example, rye, orange bitters, simple sugar, orange peel, rocks glass, ice, may be entered at step 410 and for use in flash card module 532 (see FIG. 6C). All the above core product information may be stored and accessed through the core product database 412 on central server 12.

Training system 10 will automatically generate a new core product item flash card 18 from the information entered by the operator into the point-of-sale interface system at first computer 14 or second computer 16 at steps 402 through 410 and stored on server 12 in flash cards database 522. The newly generated flash card 18 may be added to flash cards 18 used for training new employees in flash card module 532. FIG. 5C depicts screen shots of all menu categories screen 340, a list of cocktails screen 416, and a single cocktail screen 418. All of the core products items entered by the operator and stored in server 12 may be viewed by an employee with first computer 14 as shown in FIG. 5C and second computer 16 as well.

Training system 10 further includes a filter search feature that allows the employee to filter on specific aspects within training system 10. The filter feature may be used with the menu module, menu sub module and core products module to further enhance training and ensure customers they are ordering a safe item free of any allergens they may be susceptible to and to also ensure vegan and vegetarian dishes are prepared correctly. The filter feature may also be used with the menu module, menu sub module and core products module to identify particular menu items, menu sub items and core products that have particular dietary or allergen implications to enable servers to identify those dishes and quickly offer that information to patrons as the patrons make their food choices.

The filter search feature enabled by training system 10 may also be incorporated into the regular operation of the restaurant facility for use by servers and bartenders to quickly search through a database of hundreds of menu items, menu sub items and core products to which particular items or products may have contain allergens or other dietary items that may be harmful to guests. Trainees and servers can quickly search the entire database of menu items, menu sub items and core products for specific allergens and dietary items by selecting and filtering on the specific allergen and dietary items within system 10 on first computer 14 or second computer 16. The filter search feature of system 10 ensures trainers and servers can address the allergen and dietary concerns of guests with speed and accuracy to ensure a pleasant restaurant experience. Something that is just not feasible for a trainee or server to carry out if they had to search through a the hundreds of menu items, menu sub items and core products manually.

A shift set-up module 500 illustrated in FIG. 6A enables the operator to set the training shifts that may be required to be completed by the new employee based upon their department during the training period according to an embodiment of the present invention. Operators are able to add, modify or remove requirements of the training stored on server 12. Shift set-up module 500 provides an exemplary method for how an operator may enter information for the training shifts into training system 10.

The operator may enter the name of the training shift at step 502 followed by a description of the training shift at step 504 as well as shift expectations at step 506. The operator may continue to enter information for the trainee such as what attire to wear during a shift at step 508 and what the trainee should bring to the shift at step 510. The operator may also assign a trainer to a trainee at step 512.

Upon entry of the name of the training shift, the description of the shift and the shift expectations as described above, a trainer's checklist may be generated and assigned at step 516 based upon the above information from the trainer's checklist database 520 stored on server 12 and presented to the trainer on first computer 14 or second computer 16.

Further, upon entry of the name of the training shift, the description of the shift and the shift expectations as described above, a flash card module may be generated from a flash card database 522 stored on server 12 and assigned at step 518 to the trainee based upon the above information and presented to the trainer and trainee on first computer 14 or second computer 16.

FIG. 6B depicts screen shots of the various training shifts screen 524, a description of a particular training shift screen 526 along with the what to wear, what to bring and the name of the assigned trainer. Expectation screen 528 is provided along with the trainer's checklist screen 530. All of the training shifts entered by the operator and stored in server 12 may be viewed by an employee with first computer 14 as shown in FIG. 6B and second computer 16 as well. Managers and operators may review, make changes and contribute to any trainer's checklist for a particular shift to enhance the training of trainee based upon performance of the trainee during shift work or flash card reviews and testing. Checklists are readily viewable and modifiable by operators and mangers at different locations and across different shifts and time periods.

Flash card module 532 illustrated in FIG. 6C enables the new employee or trainee to enter a training mode to review and ultimately test the trainee's knowledge of the operation of the establishment through a flash card test module 800 (see FIG. 6I). FIG. 6C illustrates how a trainee may enter the flash card module 532 of the training system 10. Step 580 offers the trainee an option to enter flash card test module 800 or enter a training mode 582. Step 588 enables the trainee an option to enter a flash card review module or an assigned flash card module at 534.

Within training mode 582, the trainee may enter the assigned flash card module from step 518 or opt to review a specific set of flash cards 18 at step 534 on first computer 14 or second computer 16. Depending on which training shifts have been completed and the number of training shifts completed, a specific set of flash cards 18 may be accessed by the trainee at step 578. Those set of flash cards 18 will load from flash card database 522 stored on server 12. In either instance (assigned flash card module or specific flash cards), the trainee will view the selected flash cards 18 on first computer 14 or second computer 16 at step 536.

Now referring to FIGS. 6D and 6E, flash card module 532 will offer the trainee an option to auto play the set of flash cards 18 or to advance each flash card 18 manually by use of a mouse or touching/swiping the screen at step 538. If the trainee opts to advance each of the flash cards 18 manually at step 540, the trainee will have the choices to add a speech feature at step 544, assign colors to cards 18 at step 546 and view photos associated with the particular menu items on flash cards 18 at step 548. The photos may be accessed through a photo database 550 stored on server 12. The trainee will be offered with the option to flip flash card 18 to access the second side at step 576. The trainee may also add any notes about a particular flash card 18 at step 552. Further, the trainee may enable a feature to shuffle flash cards 18 into a different order at step 554 and select a list view at step 556 and save all of the above preferences at step 558. The trainee may exit flash card module 532 at step 560.

Referring now to FIGS. 6D, 6F and 6G, the trainee may opt to enter a random mode at step 584 and view flash cards randomly as determined by server 12. Alternatively, trainee may decide to review specific flash cards 18 at step 586. Whether reviewing flash cards in a random mode at step 584 or a set of specific flash card 18 as selected at step 586, trainee will have the option to review flash cards 18 automatically at step 538. The trainee will be offered with the choice to review both sides of flash card 18 or just one side of flash card 18 at step 556. After selection of whether to review both sides of flash card 18 or one side of flash card 18 at step 556, the trainee will be offered similar enhancements when reviewing flash cards 18 as those described above under the manual mode of reviewing flash cards 18. The trainee will have the choices to select the speed at which flash cards 18 are viewed at step 542, add a speech feature at step 544, assign colors to cards 18 at step 546 and view photos associated with the particular menu items on flash cards 18 at step 548. The photos stored on server 12 may be accessed through photo database 550 by first computer 14 or second computer 16. If the trainee opted to view both sides of flash card 18 at step 556, the trainee will be offered with the option to flip flash card 18 to access the second side at step 576 (see FIG. 6E). The trainee may also add any notes about a particular flash card 18 at step 552. Further, the trainee may enable a feature to shuffle flash cards 18 into a different order at step 554 and select a list view at step 556 and save all of the above preferences at step 558. The trainee may exit flash card module 532 at step 560.

When trainee selects the random mode to review flash cards at step 584, server 12 will present flash cards 18 to trainee in a random manner on first computer 14 or second computer 16 to trainee under flash card module 532. Randomly presenting flash cards 18 to trainee ensures the trainee cannot memorize a specific pattern of flash cards 18 under any of menu module 300, sub menu module 328 and core products module 400 to enable a more accurate and better overall training experience for the trainee which, in turn, leads to a better server or bartender for guests and the restaurant.

Trainee will be offered the selection to select a random and variable amount of time to review flash cards 18 when trainee is offered a choice to select the speed at which flash cards 18 are viewed at step 542. Trainee will not know the amount of time they will have to view flash cards 18 and correctly identify the menu item, sub menu item, or core product displayed on the flash card. This will help to further enhance the training of the trainee as this will simulate a real-life server and guest or number of guests interface when a server generally has very little time to correctly take several orders in a short amount of time.

As stated above trainee may also enter the flash card review module 900 at step 588. Flash cards 18 may be downloaded at step 902 from flash card database 522 stored server 12 onto first computer 14 or second computer 16. According to an embodiment of the present invention, the flash card review begins at step 904 with the viewing of flash card 18 at step 906. Flash cards 18 are presented randomly as determined by server 12 to trainee throughout the flash card test on first computer 14 or second computer 16. The trainee is prompted to answer a question about flash card 18 at step 908. If the trainee can identify a particular menu item, answer a question on the operation of the establishment, or answer any other question related to the establishment illustrated on flash card 18 correctly at step 910, flash card 18 is added to a correct pile database 914. If the trainee is unable to identify a particular menu item, answer a question on the operation of the establishment, or answer any other question related to the establishment on flash card 18 correctly at step 910, flash card 18 is added to an incorrect pile database 912. A review of flash cards 18 continues through step 916 until all flash cards 18 have been reviewed by trainee. Results are generated by training system 10 and displayed at step 918 and flash card review module 900 ends at step 920.

Training system 10 will note and automatically tag any incorrect answers provided by trainee for a particular flash card 18 and store the information in server 12. System 10 will alert the trainer that the trainee requires further work in this area and ensure the trainer's checklists and any further flash card reviews target the need for additional training for a particular menu item, sub menu item, or core product. System 10 will randomly generate flash cards 18 for review during flash card review module 900 or flash card test module 800 to target the areas trainee needs to work on based upon the performance of trainee during prior reviews, tests and checklist responses from the trainer (training system 10 directly links the performance on the trainer's checklist with the random generation of flash cards 18 for review and testing).

FIG. 6J depicts screen shots of a first screen 562 offering a choice of flash cards 18 to review, a flash card sample one screen 564 and a flash card sample two screen 566. Further, a flash card sample three screen 568 and a flash card sample four screen 570 are provided in FIG. 6K along with a screen 572 that a particular set of flash cards 18 have been unlocked and a congratulations screen 574. All of the flash card screens developed by the operator and stored in server 12 may be viewed by an employee with first computer 14 as shown in FIGS. 6J and 6K and second computer 16 as well.

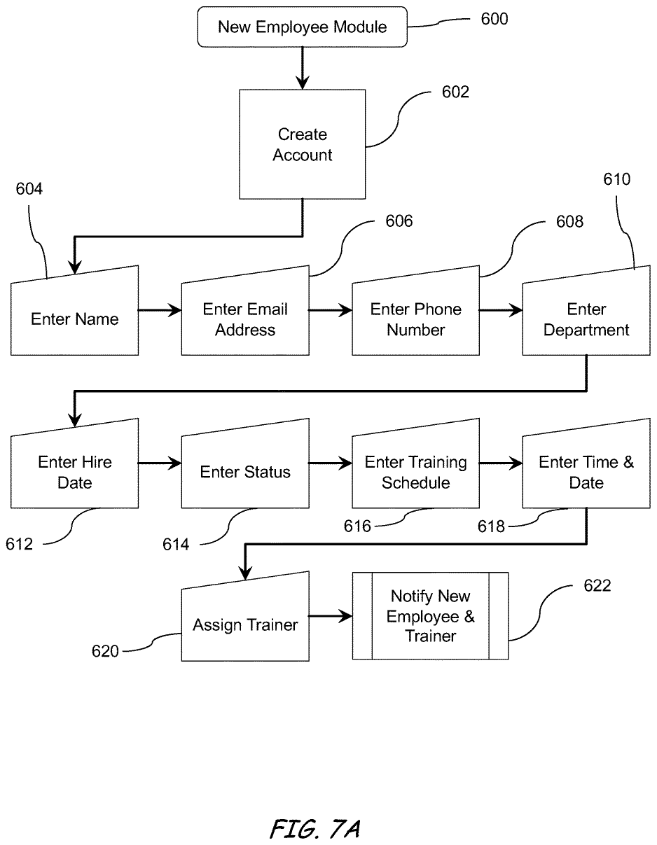

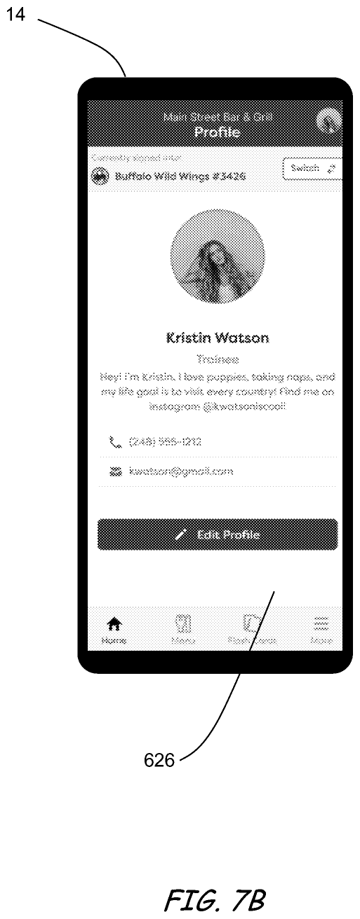

Referring now to FIG. 7A, a new employee module 600 is provided to create a new employee account at step 602 at the time of hire for storage on server 12 of training system 10 and access on first computer 14 and second computer 16 by the new employee, the operator or a manager. The operator may enter the name of the new employee at step 604 followed by an email address at step 606 and physical address and phone number at step 608. The operator may indicate the department the new employee will be working at step 610 and the date of hire as well at step 612. The status of the new employee may be entered and updated at step 614. The new employee status may change from trainee to fully trained and the like to indicate whether the employee is ready to work and be scheduled. A training schedule with date and times of the training shifts and selection of the different training shifts may be entered at step 616 and 618. The operator may assign a trainer to the new employee at step 620 and training system 10 will notify both trainer and trainee of the pairing and the shifts when training is to take place and the type of training shift for that particular period at step 622. The above information may be stored on server 12 and may be accessed by employees, including new employees during the hiring phase through first computer 14 or second computer 16. Operators and managers will also have the ability to modify any of the above to align trainers and trainees with a particular training shift, date and time. It is important to note that the above listed information is not all inclusive and other information that may be pertinent to operate an establishment may be added to the new employee module.

FIG. 7B depicts a screen shot of the contents of a typical employee screen 626. All of the employee screens developed by the operator and stored in server 12 may be viewed by employees with first computer 14 as shown in FIG. 7B and second computer 16 as well. However, it is important to note, that note all employee information may be viewed by all employees.

According to an embodiment of the present invention, the computer-implemented training system 10 may be based upon six training shifts where the trainee is paired with a trainer. Training may begin for the new employee with a face-to-face orientation with the operator or manager of the establishment where the new employee provides information for new employee module 600 depicted in FIG. 7A. The operator may then develop a training schedule and provide access for the new employee to the training schedule and all other operations of the establishment stored in server 12 through first computer 14 and second computer 16.

Each of the six training shifts follows the same structure as provided in shift set-up module 500 described above and illustrated in FIG. 6A. The trainee may be provided with a list of the expectations for the shift at step 506, what attire to wear at step 508, what to bring to the shift at step 510 and an overview of what the new employee will learn on the shift. As stated above, the trainer may be provided with the detailed checklist of all items the trainer is responsible for teaching and informing the new employee about a particular shift. Server 12 ensures the trainer and trainee are connected by the single detailed checklist through training system 10. The trainer and trainee work from the same detailed checklist to ensure all items for a particular shift are completed accurately before moving onto the next shift. If a checklist is not fully completed by both the trainer and trainee, training system 10 will not allow the trainee to move to the next training shift. The trainee can test their knowledge of what they have learned in the particular shift by reviewing and testing themselves with flash card module 532 illustrated in FIG. 6C-6I. As detailed above, all of these action items are stored on server 12 and are available for access by the employee through first computer 14 and second computer 16.

The detailed checklist discussed above, illustrated on training shift screens 524, 526, 528, 530 and maintained on server 12 of training system 10 enables for trackable and time-stamped data that can be recorded on server 12 as the trainer and trainee complete tasks on the checklist. This data can be reported an audited to ensure the trainer and trainee are completing their training tasks. Training system 10 can provide retime data on the state of training to operators or managers of the establishment that may not be present in the actual building or even same location. Training system 10 also controls the trainer/trainee governance relationship, primarily the prevention of starting a detailed checklist for a shift early without the trainer starting the session first and ensuring both the trainer and trainee are present for the training shift.

Once the new employee has completed the required number of shifts for training, the new employee is tested on their knowledge of the operations of the establishment through a flash card test. The flash card test may be offered as a “guided test” or in person test performed by the manager or trainer asking questions of the trainee about flash cards 18. Alternatively, the flash card test may be taken as a “self-test” through flash card test module 800 as illustrated in FIG. 6I on first computer 14 or second computer 16 under the supervision of the operator or manager. Still further, the “Self-test” may be taken through flash card test module 800 as illustrated in FIG. 6I on first computer 14 or second computer 16 without the supervision of the trainer or manager and scored by training system 10.

Flash cards 18 may be downloaded at step 802 from flash card database 522 stored server 12 onto first computer 14 or second computer 16. According to an embodiment of the present invention, the flash card test begins at step 804 with the viewing of flash card 18 at step 806. Flash cards 18 are presented randomly as determined by server 12 to trainee throughout the flash card test on first computer 14 or second computer 16. The trainee is prompted to answer a question about flash card 18 at step 808. If the trainee is able to identify a particular menu item, answer a question on the operation of the establishment, or answer any other question related to the establishment illustrated on flash card 18 correctly at step 810, flash card 18 is added to a correct pile database 814. If the trainee is unable to identify a particular menu item, answer a question on the operation of the establishment, or answer any other question related to the establishment on flash card 18 correctly at step 810, flash card 18 is added to an incorrect pile database 812. A review of flash cards 18 continues through step 816 until all flash cards 18 have been reviewed and flash card test module 800 ends at step 818. If the number of correct flash cards 18 held in correct pile database 814 meets or exceeds a specified threshold to pass the flash card test, the trainee is notified of a “pass” of the flash card test at step 822. If the number of correct flash cards 18 held in correct pile database 814 does not exceed a specified threshold to pass the flash card test, the trainee is notified of a “fail” of the flash card test at step 824 and the trainee will be required to repeat the training shifts where the incorrect flash cards identified an opportunity for improvement. Even if the trainee has passed the flash card test, flash card module 532 and flash card test module 800 will still be available for access by any employee to be used as a refresher on existing menu items or operations that are not common and for any new menu items or operations that may be added the establishment and the database stored on server 12.

An overview of the six shifts is provided below. However, it is important to note, that the operator or manager may decide the optimal number of training shifts based upon the menu items and operations of their particular establishment. The “Follow One” may be the initial shift for the new employee and this shift allows the trainee to follow or shadow the server or trainer. The trainee may simply observe the trainer as the trainer interacts with customers and the remainder of the staff at the establishment. The trainer may explain and teach as they go about their shift. “Expo One” is a shift where the trainee may be stationed in the kitchen with an expeditor where the trainee observes and begins to learn about the menu as well as the garnishing, traying and running food process. The trainee is paired with a different server or trainer from the “Follow One” shift in the “Follow Two” shift. In the “Follow Two” shift, the trainee is expected to complete all the mechanical steps a server would take such as ringing on the point-of-sale interface system computer, garnishing drinks, carrying trays, pre-bussing, etc. everything a server would do but for interacting with guests. The trainee is once again paired with the expeditor in the “Expo Two” shift and the trainee takes more of a hands-on role by traying, garnishing and running food to guests while continuing to learn the menu. The “Follow Three” shift is a role reversal. Now the trainer follows or shadows the trainee and counsels the trainee as the trainee interacts with customers. The “Circuit Shift” is a unique shift and actually the trainees first training shift where the trainee learns the basics of the different departments and spends multiple hours with each department to learn about the different departments.

As described above, each of the shifts may be added, updated and detailed in the shift set-up module 500 by the operator or manager. Also, at the completion of each shift, flash card module 532 for a particular shift is reveled to the trainee so the trainee can review the knowledge they learned on a particular shift.

Computer-implemented training system 10 may be enabled in the manners described above to enhance the learning experience for the new employee or trainee. Flash card module 532 experience presents a fun and interesting way to teach new employees the operations of a particular establishment by utilizing a device individuals use every day, first computer 14, such as a smartphone device or tablet, or second computer 16, such as a desk top computer or lap top computer. When presented with an accessible and fun way to learn a number of new tasks, new employees will stay engaged and want to learn. The different options for reviewing flash cards 18 and learning the different menu items also engages the new employee by providing options for the employing to learn at their own pace and learn in the best manner that suits the particular employee. The eagerness to learn will increase retention and will lead to a faster and better trained employee that can quickly enhance the operations and increase the business of the establishment. Further, computer-implemented training system 10 greatly improves the ability to ensure training programs are completed accurately and in a timely manner to enable a new server to contribute positively to the operation of the establishment immediately after completing training. Training system 10 provides operators and managers with trackable audit paths, reporting, and delivering the consistent information to all employees of the establishment through server 12. More importantly, training system 10 removes the variables of a human's interpretation of each training step and requirement and ensures the establishment and multiple establishments operate consistently under the same system 10.

Training system 10 also ensures accountability of all users especially the trainer and trainee. By maintaining a role-specific (trainer/trainee) event record for guided training sessions, including session initiation, trainee step completion, synchronized progress updates, trainer sign-off, and completion notes, an auditable record of participation and completion is available that is not available from the standard human-only shadowing training process.

Further, training system 10 can developed an enhanced training workflow/build paths based upon performances of the trainee during shift training work and flash card review and testing. The trainee's performance information is stored on server 12 and accessible by training system 10. Training system 10 knows the deficiencies of the trainee based upon the information system 10 receives from the information provided through the checklists and flash card review and testing and stored on server 12. Training system 10 can adjust the information on the checklists and the flash card training to ensure the trainee addresses the deficiencies.

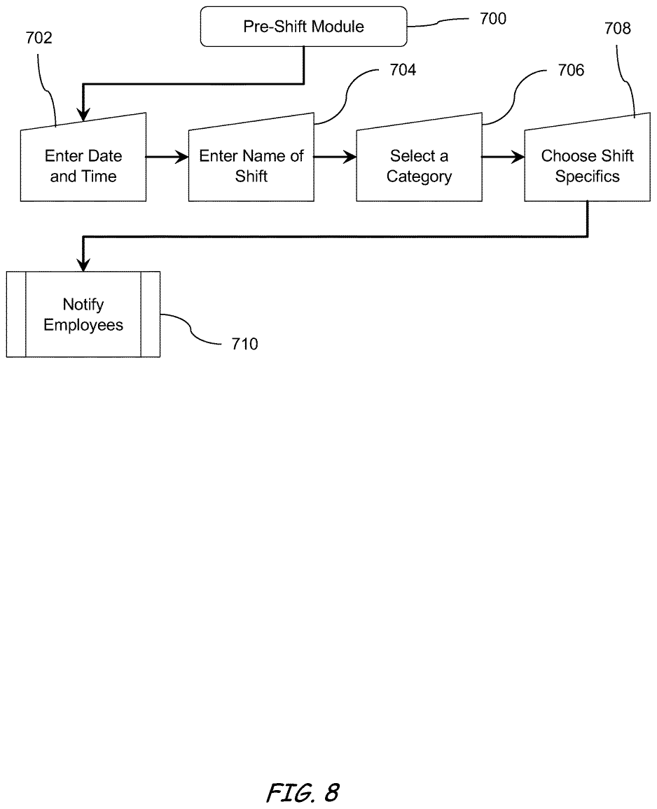

Computer-implemented training system 10 may also include other modules to enhance continuous training for all employees. FIG. 8 illustrates a flow diagram for a pre-shift module 700 that may also be included to provide operators and managers an opportunity to interface directly with employees through first computer 14 and second computer 16. Operators or managers may enter the date and time of a particular shift at step 702, whether the shift is breakfast, brunch, lunch, dinner, and the like at step 704. Operators will have an opportunity to select a particular category such as special reservation/party, general announcement, and the like at step 706 and to indicate whether the particular announcement or information is for select employees (for example, employees on a specific shift), all employees or some other subset of employees at step 708. Employees will be notified through first computer 14 and second computer 16 at step 710 and as described above. The pre-shift module enables announcements and information regarding the establishment to be effectively and timely sent to all employees. The pre-shift module may also require each employee to acknowledge receipt of an announcement so a manager may be able to track which employees have received the announcements and when those employees received the information.

Further modules may also be included with computer-implemented training system 10 to provide greater feedback to employers from employees. A reporting module may provide the owner or manager of an establishment with information about employees and the use of the computer-implemented training system 10. Information may include time spent with training system 10, time spent in actual training with flash card module 532 or live training and associated wages due to the employee. Other information may include results of testing from flash card test module 800 and overall test data along with the retention rate of each employee as the employee trains. Statistics for trainers may also be kept to determine the effectiveness of the trainer as they train new employees. It is important to note that the reporting module may include other information gathering aspects and is not just limited to those statistics described above.

A suggestion box may also be included with computer-implemented training system 10 the allows any employee to provide suggestions or feedback to the owner or manager of the establishment to improve the work environment and ultimately the customer experience. The suggestions or feedback may be provided by employees that may be identified or anonymously. Employees may use training system 10 to provide the suggestions or feedback and the owner or manager may receive that information by email to ensure the anonymity of the employee. Suggestions or feedback that can be provided anonymously may be truly valuable feedback to any restauranteur because they realize it may be the most honest information they can receive to help improve their business.

A voting feature provides the owner or manager an opportunity to gain insights from employees through voting. The voting feature also empowers employees and makes them feel more like a team member by giving the employees a “voice” in aspects of the operation of the establishment. Managers will have the option to structure voting campaigns using training system 10 and employees may exercise their right to vote using training system 10 as well.

A messaging feature is also provided to alert employees to any of the above features such as a reminder to use the suggestion box or there may be an open vote. The messaging feature may also be used to alert employees to any changes in training system 10 such as new menu items, changes to the employee handbook, changes to company policies and the like. The messaging feature provides a quick and effective way to ensure all employees are notified and require employees to acknowledge receipt of the message as described above to ensure the message was delivered and received. The messaging feature may allow managers to communicate with the entire staff, a specified group of employees or individuals. The messaging feature may also enable social networking among staff enabling employees to post, chat, comment and the like.

The process of implementing computer-implemented training system 10 may begin with a discovery phase between a restaurant owner or manager and an agent of the company providing training system 10. The discovery phase may include the owner or manager providing an existing employee handbook, if one exists, all menus, a floor plan for the restaurant including location of all tables, booths and the like, any existing training materials, and any other available pertinent information that may be obtained through a questioner. Once provided, the agent may begin the backend setup process for training system 10 on first computer 14 or second computer 16, as illustrated in FIG. 2-5B, to store a custom version of training system 10 on server 12. Computer-implemented training system 10 may be tailored to fit the specific needs of the restaurant for the owner and manager through the above-described set-up process. Once the custom training system 10 has been developed, the owner and manager may begin using training system 10 to train new employees and improve the work product of all employees to enhance the customer experience and ultimately improve the business of the restaurant.

The training experience for the new employee begins with an orientation meeting with the manager of the restaurant. During the meeting, the new employee may be introduced to computer-implemented training system 10 through first computer 14 or second computer 16. The manager will illustrate and describe to the new employee how training system 10 operates on first computer 14 or second computer 16 and begin to create a training schedule for the new employee and assign trainers for each shift to guide the new employee.

Upon accessing training system 10 for the first time, the new employee will be taken through the new employee module as illustrated in FIG. 7A to create a profile such as the one depicted in FIG. 7B. The employee will be provided access to their new training schedule and may download their schedule to any type of calendar software such as Google, Outlook and the like. Employees will be given the option to peruse and become familiar with training system 10 and read the employee handbook or the policies module (see FIG. 3A).

Once their training commences, the employee will have access to their training schedules, menus, flash card module 532 (see FIG. 6C-6K), and other information pertinent to the operation of the restaurant. Training modules or shifts may be completed in order. As a particular training shift is completed and concepts learned, a new training module will open for the employee to navigate and learn. Training will continue in this manner until the employee has completed all the training modules. Once the employee is confident they are fluent in all aspect of the operation of the restaurant, the employee may sit for their face-to-face flash card test with the manager or take the test online through flash card test module 800 of training system 10 with or without the manger present as described above. If the employee passes the flash card test, the status of the employee will be changed from “Trainee” to “Trained”. If the employee fails any aspect of the test, the manager and employee develop further training to address the shortfalls of the employee to ensure the employee is properly trained. The employee may retake the flash card test after completing any further training in an effort to achieve a passing grade. The process of retraining and retaking the test may continue to ensure all employees are properly trained prior to changing status to “Trained”.

Computer-implemented training system 10 may also enable scheduling functionality for the owner or manager. Section tracking by managers through training system 10 will enable mangers to track which sections have been assigned to which employees to ensure a fair distribution of sections to employees to optimize their earnings. Section tracking will also ensure managers can manage employees across larger parties along with the various sections.

Training system 10 also enables managers to maintain employee files and allows managers to store any notes regarding a particular employee such as notes on absences, compliments, write-ups, tardiness, vacation time, perfect attendance and the like. Servers and bartenders may work on a star-based rating system-the higher the star rating, the better the performance of the employee. Training system 10, through the point-of-sale interface system, will determine the star rating for a particular server or bartender based upon the speed and accuracy at which the employee performs. This star-based data may be stored on server 12 and used by system 10 to automatically generate shift priority and hours of work for the employees. The higher the star-rating for an employee, the better the shift and the more hours the employee can work. An auto-scheduler feature of system 10 will also develop a comprehensive schedule based on the star-rating of employees in a matter of seconds, utilizing data inputs stored on server 12 from the point-of-sale interface systems on computers 14, 16, such as employee competency, best availability, and shift priority to ensure scheduling accuracy. This will help to ensure a particular shift is not full of underperformers that will impact the operation of the establishment. This scheduling can be completed by system 10 in the fraction of time it would take a human to generate and with far more accuracy. The auto-schedule feature will also enable a manager to make changes quickly including the ability to approve shift swapping by employees. Further, training system 10 may include simple shift-based check lists for side work duties, opening, closing and the like so employees and managers do not overlook any required activities to enable the smooth operation of the restaurant.

Still further, training system 10 may allow modifications to modules that enable the continuous education of employees. Employees may want to learn more about a particular subject or subjects at the restaurant. Perhaps an employee has aspirations of being promoted to a manager and operating the entire restaurant. Training system 10 may include a passport module that enables employees to select particular items of interest related to the restaurant they may want to learn more about to enhance their knowledge. These modules may be a link to certain reading materials, a video, a book, attending an event or workshop and the like. Further, the manager may require some added training for a new product or process that may be introduced to the industry. The passport module would allow the employee and manager to track any new learning or module that may have been completed by the employee and noted as continuous education and improvement for the betterment of the employee and ultimately the restaurant itself.

One challenge a restaurant faces is the fact that many experienced servers or bartenders do not want to spend their precious time training new employees. Some restauranteurs offer monetary incentives or complimentary meals to trainers to take on this burden, but often the incentives are ineffective. Training system 10 may provide a better option for providing incentives to trainers. Because all the information for both trainers and trainees are tracked by training system 10, it is much easier for a manager to determine the performance of the trainer by tracking the training statues of the trainee. This performance information would enable the manger to establish a point system for trainers and allow points to be awarded to the trainer as the trainee completes tasks properly on their way to becoming a trained employee. Further, as the trained employee continues to progress and establishes themselves as an experienced server or bartender, the trainer may continue to be award points for the successful training of an experienced server or trainer. Also, the longer that employee remains with the restaurant, the original trainer may continue to be awarded points for the longevity of the trained employee. Training system 10 will ensure the ease of tracking the bonus points for the trainer. The bonus points may be traded in for monetary value, meals, trips and the like all to entice a trainer to take on a trainee and continue the success of the restaurant.

Still further, training system 10 enable servers and bartenders to connect directly with restaurant vendors. Vendors to the restaurant industry are constantly attempting to connect with restaurants through owners and managers to showcase their products and convince the restaurants to offer their products for sale to their patrons. Vendors will offer various incentives to owners and managers in return for offering their products in their restaurant. However, it is the servers and bartenders that actually offer the products for sale and can influence the sale to customers. Many times, vendors only have access to servers and bartenders while they are working and often servers and bartenders do not have time for their sales pitch. Training system 10 will enable servers and bartenders to reach out to vendors through the messaging system to learn about their new products as well as the incentives the servers and bartenders can earn for offering for sale their product. This anytime contact will enable vendors, servers and bartenders to meet through training system 10 while the servers and bartenders are not busy working, to learn more about the products offered by the vendor as well as the many incentives available.

The food service industry is extremely intertwined and many employees have worked together and have grown to know one another. Training system 10 may enable these employees an opportunity to stay connected as they move from one restaurant to another. A chance for food service industry employees to stay connected and interact is extremely relevant and compelling. Training system 10 will ensure servers, bartenders and other restaurant employees can share information about their restaurants, their likes and dislikes and information about vendors, their brands and what products are selling best. All information that can be used to further improve the business of each restaurant.

Training system 10 can also provide owners and managers a platform to rate and exchange information with other restaurants on the performance of prior employees. One of the reasons why staff turnover is a large problem for the food service industry is because employees do not have accountability for their performance. Employees know restaurants are desperate for staff and will often hire on the spot without checking references to fill needed positions. Owners and managers can rely on training system 10 as a quick way to share information about an ex-employee and gain information on a potential new employee prior to hiring. Again, this type of readily available reference system of training system 10 may be used to enhance the customer experience through great employees and improve the business of each restaurant.

The present invention has been particularly shown and described with reference to the foregoing embodiments, which are merely illustrative of the best modes presently known for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method within the scope of these claims and their equivalents be covered thereby. This description of the invention should be understood to include all novel and non-obvious combination of elements described herein, and claims may be presented in this or a later application to any novel non-obvious combination of these elements. Moreover, the foregoing embodiments are illustrative, and no single feature or element is essential to all possible combinations that may be claimed in this or a later application.

What is claimed is:

1. A computer-implemented system for dynamically synchronizing point-of-sale data and adaptive training content within a networked food service environment, the computer-implemented system comprising:
at least one central server comprising a data-transformation engine and one or more relational databases specific to a food service establishment and employees, said one or more relational databases of establishment-specific data including:
menu data comprising a plurality of menu items, menu sub-items, and core products;
training shift data comprising shift set-up, pre-shift information, training shift data, and training module content;
a flash card module comprising a plurality of flash card learning content; and
a flash card test module comprising a plurality of flash card testing content presented randomly to an employee trainee as determined by said at least one central server;
a plurality of distributed computing nodes configured as point-of-sale interface systems, including at least one first computer and at least one second computer communicatively coupled to said at least one central server via said computer network;
wherein said at least one central server executes said computer-implemented system comprising executable instructions that:
automatically intercepts said establishment-specific data from said point-of-sale interface systems to capture real-time modifications to said establishment-specific data;
execute a dynamic mapping algorithm that transforms said establishment-specific data from said point-of-sale interface systems into said flash card learning content, aligns said flash card learning content with respective said training module content, and ensures said flash card learning content automatically updates and maintains parity with said establishment-specific data through said point-of-sale interface systems all without manual intervention;
automatically assigns a designated said flash card module based on the identified employee trainee record in response to completion data from corresponding said training shift data received from said at least one second computer;
executes a sequence of said flash card testing content within said flash card test module for delivery to the employee trainee via said at least first computer or said at least one second computer;
evaluate and score responses to said flash card testing content from the employee trainee and store performance metrics within an employee trainee profile database;
generate an asynchronous auditable training record by synchronizing said employee trainee profile database and said training shift data between said at least one first computer and said at least one second computer across a plurality of training shifts;
monitor for changes to said training shift data and, upon detecting a modification, automatically synchronize and maintain updated training content across said at least one central server, said at least one first computer, and said at least one second computer without manual intervention;
dynamically modify a subsequent training sequence for the trainee by cross-referencing real-time performance metrics retrieved from said auditable training record with results from said flashcard test module; and
update the employee trainee interface in real time to reflect the synchronized training assignments and performance data retrieved from said at least one central server;
wherein said at least one first computer presents to the employee trainee a graphical user interface comprising a training dashboard displaying the training progress, training assignments, and flash card test scores of the employee trainee retrieved in real time from said at least one central server.

2. The computer-implemented system as recited in claim 1, wherein dynamically modifying said training sequence includes automatically tagging incorrect responses to said flash card testing content and updating said employee trainee profile database to prioritize deficiencies in subsequent said plurality of training shifts according to said incorrect responses.

3. The computer-implemented system as recited in claim 2, wherein a trainer's checklist is automatically generated by said at least one central server based on specific said training shift data and presented as an interactive module on said at least one first computer.

4. The computer-implemented system as recited in claim 3, wherein said at least one central server dynamically modifies said trainer's checklist to prioritize deficiencies according to said incorrect responses.

5. The computer-implemented system as recited in claim 1, wherein said digital flash card testing module includes a randomization engine configured to present said flash card testing content at variable time intervals.

6. The computer-implemented system as recited in claim 1, wherein said at least one central server is configured to automatically update said flash card learning content upon detecting a modification to said establishment-specific data through said point-of-sale interface systems without manual intervention.

7. The computer-implemented system as recited in claim 1, wherein said menu data includes a name, ingredients, a photo, dietary, allergen, gluten free, vegan and vegetarian information.

8. The computer-implemented system as recited in claim 7, wherein said plurality of flash card learning content depicts said menu data.

9. The computer-implemented system as recited in claim 8, wherein said flash card module includes:
a first option to automatically advance each of said plurality of flash card learning content;
a second option to review both sides of each of said plurality of flash card learning content;
an audible option to announce the information on each of said plurality of flash card learning content;
a third option to set a color of each of said plurality of flash card learning content; and
a fourth option to set an amount of time that each of said plurality of flash card learning content is viewable.

10. The computer-implemented system as recited in claim 1, wherein said flash card test module further includes a set threshold of correct answers that must be met or exceeded to pass said flash card test module.

11. The computer-implemented system as recited in claim 1, wherein said at least one central server includes a filter option to quickly isolate said menu data attributes comprising allergen data, gluten-free status, vegan status, or vegetarian status.

12. A method for an implementation of a computer-implemented system for dynamically managing and executing establishment specific training for employee trainees within a food service environment, the method comprising steps of:
storing in at least one central server one or more structured relational databases of establishment-specific data comprising:
a menu module storing a plurality of menu items, each record including fields for a menu item name, category, description, ingredients, image reference, cooking specifications, allergen attributes, and upsell relationships;
a shift set-up module storing a plurality of training shift records, each record including a name, description, expectations, required attire, associating trainer identifiers, employee trainee identifiers, and pre-assigned digital checklist identifiers;
a flash card module linking each said menu item record to a corresponding digital flash card for interactive training; and
a flash card test module linking each said menu item record to a corresponding digital flash card for interactive testing;
establishing, via said at least one central server, network connections between at least one first computer and at least one second computer, each configured as a point-of-sale interface and to retrieve and display a training dashboard, said plurality of menu items, and said digital flash cards from said flash card database;
automatically generating, by said at least one central server, a digital flash card based upon information entered into said second computer;
automatically generating, by said at least one central server, a training session dataset by merging one of said plurality of training shift records with corresponding said digital flash cards responsive to a session initiation command received from said at least one first computer or said at least one second computer;
transmitting, by said at least one central server, said training session dataset to said at least one first computer or said at least one second computer in a format optimized for local caching and offline review;
tracking trainee interaction events including flash card review duration, input accuracy, and sequence completion, and logging said trainee interaction events into said training dashboard linked to said employee trainee identifier; and
computing, by said at least one central server, a training competency score based on logged said trainee interaction events and said interactive testing results and updating the trainee status record in said plurality of training shift records database to indicate training completion.

13. The method for the implementation of said computer-implemented system as recited in claim 12, wherein said establishment-specific data stored in said at least one central server further comprises:
a general information module, said general information module comprising an establishment name, an address, a location description, an organizational chart, an employee handbook, a concept and a mission of the food service establishment and stored as said one or more databases on said at least one central server;
a menu sub module, said menu sub module comprising a plurality of menu sub items of the food service establishment and stored as said one or more databases on said at least one central server, each of said plurality of menu sub items include a name, ingredients, a photo, dietary, allergen, gluten free, vegan and vegetarian information; and
a core product module, said core product module comprising a plurality of core product items of the food service establishment and stored as said one or more databases on said at least one central server, each of said plurality of core product items include a name, category, ingredients, a product description, a photo and key information.

14. The method for the implementation of said computer-implemented system as recited in claim 13, wherein said flash card module links each of said plurality of menu sub items and said plurality of core products to a corresponding digital flash card for interactive training.

15. The method for the implementation of said computer-implemented system as recited in claim 14, wherein said flash card test module links each of said plurality of menu sub items and said plurality of core products to a corresponding digital flash test card for interactive testing.

16. The method for the implementation of said computer-implemented system as recited in claim 14, wherein said flash card module includes:
a first option to automatically advance each of said digital flash cards;
a second option to review both sides of each of said digital flash cards;
an audible option to announce the information on each of said digital flash cards;
a third option to set the color of each of said digital flash cards;
a fourth option to set an amount of time that each of said digital flash cards is viewable.

17. The method for the implementation of said computer-implemented system as recited in claim 12, wherein tracking trainee interaction events further comprises the steps of automatically tagging incorrect responses to from said interactive training and said interactive testing and updating said trainee status record to prioritize deficiencies in subsequent said plurality of training shift records according to said incorrect responses.

18. The method for the implementation of said computer-implemented system as recited in claim 17, further comprising the steps of automatically generating a trainer's checklist is automatically generated by said at least one central server based on specific said plurality of training shift records and presented as an interactive module on said at least one first computer.

19. The method for the implementation of said computer-implemented system as recited in claim 18, further comprising the step of dynamically modifying, via aid at least one central server, said trainer's checklist to prioritize deficiencies according to said incorrect responses.

20. The method for the implementation of said computer-implemented system as recited in claim 12, further comprising the step of automatically updating, via said at least one central server, said flash card learning content upon detecting a modification to said establishment-specific data through said at least on first computer and said at least one second computer without manual intervention.
